(19) United States
(12) Patent Application Publication
(10) Pub. No.: US 2015/0116853 A1
(43) Pub. Date: Apr. 30, 2015

(54) SAFETY AND FLEXIBLE MIRROR STRUCTURE WITH FLEXIBLE BACK PAD

(71) Applicant: Chin-Yeh Co., Ltd., Taipei City (TW)

(72) Inventor: Ein-Yiao SHEN, Taipei City (TW)

(73) Assignee: Chin-Yeh Co., Ltd., Taipei City (TW)

(21) Appl. No.: 14/160,003

(22) Filed: Jan. 21, 2014

(30) Foreign Application Priority Data
Oct. 24, 2013 (TW) 102138529

(51) Int. Cl. G02B 5/08; G02B 1/10

(52) U.S. Cl. CPC G02B 5/0808; G02B 1/105
USPC 359/870

(57) ABSTRACT

A safety and flexible mirror structure with a flexible back pad, comprises: a reflective material layer, which is a coating material that reflects light and has two surfaces; a flexible transparent material layer, which integrates with one of the two surfaces of the reflective material layer, and the flexible transparent material layer is transparent and reflects allochthonous images; and a flexible back pad layer, which integrates with another surface of the reflective material layer and makes the safety and flexible mirror structure to be shatterproof.

The current application claims a foreign priority to the patent application of Taiwan No. 102138529 filed on Oct. 24, 2013.

### BACKGROUND OF THE INVENTION

1. Field of the Invention

The present invention generally relates to a safety and flexible mirror structure with a flexible back pad, more particularly to an architectural material that can be applied to outdoor walls, wall materials, compartments, and even interior compartment decorations, furthermore, the fields of science, electronic, vehicle materials, solar concentrators, etc., and can be divided into pieces in order to conveniently collect, store, and automatically open and retract, in particular, an integration of the safety and flexible mirror structure with a flexible back pad is broadly applied to every science fields.

2. Description of the Prior Art

Due to increasing aesthetics and architectural technologies, glass materials have been mostly applied to wall materials, compartments, and even interior compartment decorations. This is about that a raw glass material is a transparent coating film, and the transparent coating film has been applied to a large amount of buildings before those buildings in modern times were constructed. At that time, the transparent coating film was used for windows in order to let light be through, and to embed glass into a window was very common. Medieval Gothic architectures have changed a window that is shaped as a hole to another kind of window with a larger area. Subsequently, in 19^{th} century, glass greenhouse has ushered raw glass materials in a new era.

Before 19^{th} century, glass already plays a main role in the field of architecture. On the other hand, back into an earlier time, there were a lot of architectures that adopt the design of dormer in 18^{th} century. Nowadays, the all wall surfaces of a glass greenhouse are curtain walls in addition to dormers and windows. As it can be seen, it is the time that a raw glass material becomes an integral coating film. Besides, The Crystal Palace in London has expanded the applications of raw glass materials, so that a raw glass material as a main material in architecture is inevitable.

Because of the hardness of glass, the raw glass material is relatively fragile either. For instance, once a collision happens, cracks or breaks happening on the raw glass material may damage people so as to cause dangers in a construction site. In addition to the architectural field, other fields as science, electronic, vehicle materials, solar concentrators, etc. may also be applied with glass materials. Those fields may also be applied in high temperature environments, and sometimes a normal glass material will possibly explode or crack.

As a conclusion, in addition to a glass characteristic, providing an architectural material that has other characteristics as bendability, crash proofing, toughness, light weight, easy-to-carry, heat resistant, etc. to replace prior raw glass materials is the best solution to figure out the disadvantages in prior arts.

### SUMMARY OF THE INVENTION

In one aspect of the present invention is to provide a safety and flexible mirror structure with a flexible back pad, which can be a glass material, in particular, other characteristics as bendability, crash proofing, toughness, light weight, easy-to-carry, heat resistant, etc. are also brought by the safety and flexible mirror structure in order to replace prior raw glass materials, so the safety and flexible mirror structure with a flexible back pad is obviously better than prior raw glass materials.

To approach the above aspect, the safety and flexible mirror structure with a flexible back pad, comprises: a reflective material layer, which is a coating material that reflects light and has two surfaces; a flexible transparent material layer, which integrates with one of the two surfaces of the reflective material layer, is transparent and reflects allochthonous images; and a flexible back pad layer, which integrates with another surface of the reflective material layer and makes the safety and flexible mirror structure to be heatproof.

More specifically, the reflective material layer is a sliver layer, and the silver layer is formed as a silver mirror on the flexible transparent material layer.

More specifically, the reflective material layer is a copper layer, and the copper layer is formed as a copper mirror on the flexible transparent material layer.

More specifically, the reflective material layer is an alloy layer, and the alloy layer is formed as an alloy mirror on the flexible transparent material layer.

More specifically, the reflective material layer is an electroplating chemical fusion layer, and the electroplating chemical fusion layer is formed as an electroplating chemical fusion mirror on the flexible transparent material layer.

More specifically, the reflective material layer is a metal fusion layer, and the metal fusion layer is formed as a metal fusion mirror on the flexible transparent material layer.

More specifically, the flexible transparent material layer is a flexible transparent material.

More specifically, the flexible transparent material layer is transparent film, or flexible plastic.

More specifically, the flexible plastic is made of polyethylene terephthalate (PET).

More specifically, the flexible plastic is made of polyethylene naphthalate (PEN).

More specifically, the flexible plastic is made of polyvinylchloride (PVC).

More specifically, the flexible plastic is made of polyimide (PI).

More specifically, the flexible plastic is made of polypropylene (PP).

More specifically, the flexible back pad layer is a polyethyleneimine (PEI).

More specifically, the flexible back pad layer is a tear-proof paper.

More specifically, the flexible back pad layer is a cloth.

More specifically, the flexible back pad layer is a liquid silicone gel.

More specifically, the flexible back pad layer is a liquid silicone rubber.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic perspective structural view of the safety and flexible mirror structure with a flexible back pad of the present invention;

FIG. 1B illustrates a schematic sectional structural view of the safety and flexible mirror structure with a flexible back pad of the present invention; and

FIG. 2 illustrates a schematic view of a preferred embodiment of the safety and flexible mirror structure with a flexible back pad of the present invention.

### DETAILED DESCRIPTION OF THE INVENTION

Following preferred embodiments and figures will be described in detail so as to achieve aforesaid objects.

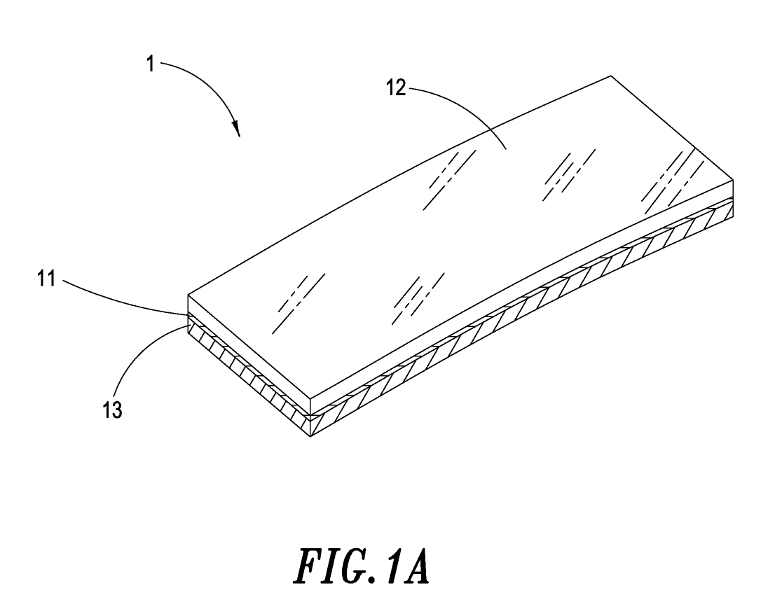

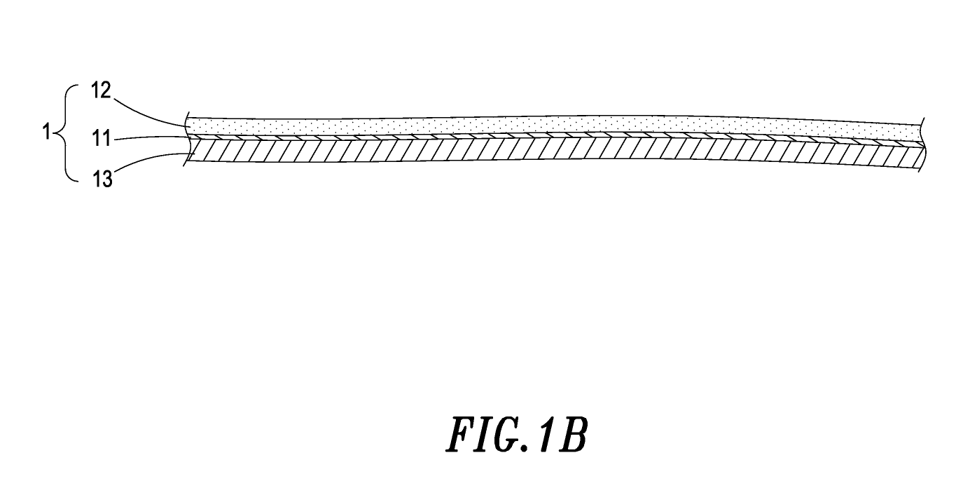

Please refer to FIG. 1A and FIG. 1B, which illustrates a schematic perspective structural view of the safety and flexible mirror structure with a flexible back pad of the present invention and a schematic sectional structural view of the safety and flexible mirror structure with a flexible back pad of the present invention. As shown in figures, the safety and flexible mirror structure 1 comprises a reflective material layer 11, a flexible transparent material layer 12 and a flexible back pad layer 13. The reflective material layer 11 has two surfaces. The flexible transparent material layer 12 integrates with one of the two surfaces of the reflective material layer 11. The flexible back pad layer 13 integrates with another surface of the reflective material layer 11.

When the reflective material layer is a coating material that reflects light, for example a silver layer, a copper layer, an alloy layer, an electroplating chemical fusion layer, or a metal fusion layer, then a silver mirror, a copper mirror, an alloy mirror, an electroplating chemical fusion mirror, or a metal fusion mirror is formed. When light goes through the flexible transparent material layer 2 to the reflective material layer 11, the flexible transparent material layer 12 is flexible and transparent and the reflective material layer 11 is able to reflect light, the reflective material layer 11 thus reflect images to the flexible transparent material layer 12, so that the flexible transparent material layer 12 is just like a mirror to reflect allochthonous images.

In addition, the flexible back pad layer 13 is made of polyethyleneimine (hereinafter referred to PEI). The PEI provided by the present invention is a PEI film made by MITSUBISHI PLASTICS, and the characteristics of the PEI film are thermoplastic and super heat-resistant. Other characteristics of PEI have heat durability, chemical proofing, weather resistance, flame resistance, thermoform, etc. In particular, a glass transition temperature of PEI is very high in the field of thermoplastic base resin, and its sizes are smaller when the temperature approaches to 210° C., therefore it keeps elongating when in high temperature. In practice, a surface with the flexible back pad layer 13 is adhered to a wall surface or a surface of any other building after integrating the flexible back pad layer 13 with the reflective material layer 11, and the safety and flexible mirror structure 1 has a characteristic of high heat resistance.

As aforesaid, in addition to the mirror function, the safety and flexible mirror structure 1 consisted of the reflective material layer 11, the flexible transparent material layer 12 and the flexible pad layer 13 further has the characteristics of bendability, crash proofing, toughness, light weight, easy-to-carry, heat resistant, etc. As a conclusion, applying the safety and flexible mirror structure 1 to the field of architecture, it will have a good performance in safety; in other words, cracks on a traditional glass may not happen on the safety and flexible mirror structure 1 so as to highly increase safety.

The flexible transparent material layer 12 is made by the flexible and transparent materials of transparent film, tear-proof paper, cloth, flexible plastic, etc. That is why the safety and flexible mirror structure 1 is with the characteristics of bendability, crash proofing, toughness, light weight, easy-to-carry, heat resistant, etc. Hence, the flexible transparent material layer 12 is more convenient than prior hard glass materials in the aspect of cutting; in other words, expensive cutting machines will be no more existed for cutting the flexible transparent material layer 12, and furthermore, cutting prior hard glass materials causing operators damaged may not happen again.

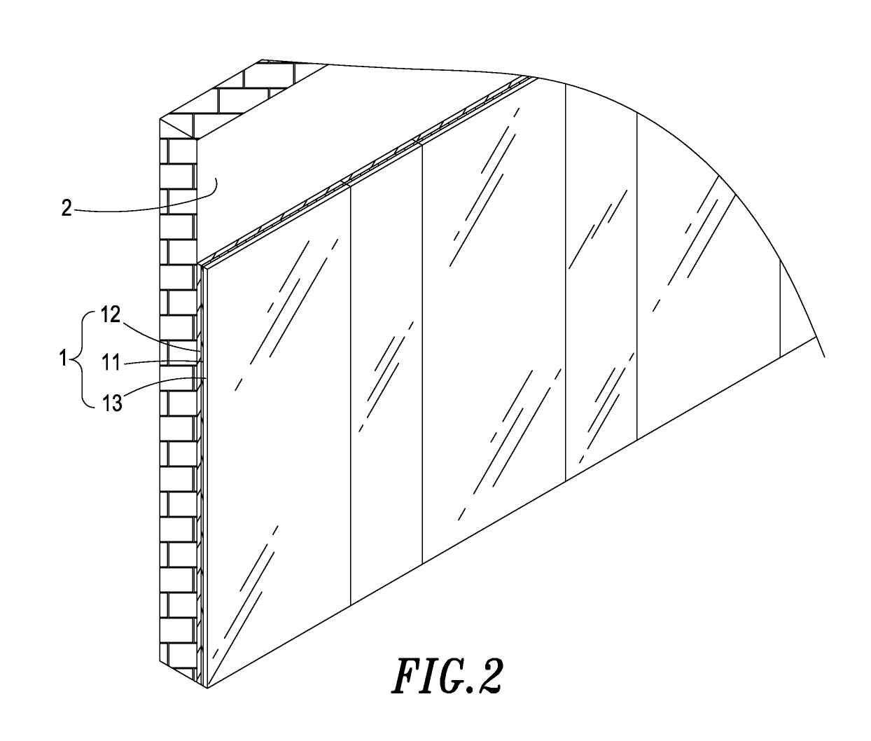

The present invention can be applied to outdoor walls, wall materials, compartments, and even interior compartment decorations. As shown in FIG. 2, that is a wall of a dancing classroom, and such dancing classroom may be equipped with larger sizes of reflective plates. As a matter of fact, the flexible back pad layer 13 of the safety and flexible mirror structure 1 can be stick on an inner wall surface 2 of the dancing classroom. Subsequently, the flexible transparent material layer 12 is toward the interior of the dancing classroom, and a dancer can practice in front of the flexible transparent material layer 12 for seeing dancing actions himself.

Except for architecture, the safety and flexible mirror structure 1 can be applied to other fields, for example science, electronic, vehicle materials, solar concentrators, etc. Those fields may also use prior hard glass materials and be in high temperature environments, some kinds of heat-resistant glass materials are then developed. Although such heat-resistant glass materials appears, they are still fragile and heavy, so as to damage operators all the time. As it can be seen, applying the present invention is able to prevent traditional disadvantages.

Compared to prior arts, the safety and flexible mirror structure of the present invention has the advantages listed below:
1. The safety and flexible mirror structure with a flexible back pad provided by the present invention can be as a glass material, in particular, other characteristics as bendability, crash proofing, toughness, light weight, easy-to-carry, heat resistant, etc. are also brought by the safety and flexible mirror structure in order to replace prior raw glass materials.
2. The safety and flexible mirror structure with a flexible back pad provided by the present invention can be applied to outdoor walls, wall materials, compartments, and even interior compartment decorations, furthermore, the fields of science, electronic, vehicle materials, solar concentrators, etc. are the targets as well, in particular, components of future mobile phones, solar concentrator materials, expanding materials in air space, collections, architectural materials, and banners are expending application fields.
3. The safety and flexible mirror structure with a flexible back pad provided by the present invention can be divided into pieces in order to conveniently collect, store, open, and retract. In particular, an integration of the safety and flexible mirror structure with a flexible back pad is broadly applied to every science fields.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A safety and flexible mirror structure with a flexible back pad, comprising:
a reflective material layer, being a coating material that reflects light and having two surfaces;
a flexible transparent material layer, integrating with one of the two surfaces of the reflective material layer, being transparent and reflecting allochthonous images; and
a flexible back pad layer, integrating with another surface of the reflective material layer and making the safety and flexible mirror structure to be shatterproof.

2. The safety and flexible mirror structure with a flexible back pad according to claim 1, wherein the reflective material layer is a sliver layer, the silver layer being formed as a silver mirror on the flexible transparent material layer.

3. The safety and flexible mirror structure with a flexible back pad according to claim 1, wherein the reflective material layer is a copper layer, the copper layer being formed as a copper mirror on the flexible transparent material layer.

4. The safety and flexible mirror structure with a flexible back pad according to claim 1, wherein the reflective material layer is an alloy layer, the alloy layer being formed as an alloy mirror on the flexible transparent material layer.

5. The safety and flexible mirror structure with a flexible back pad according to claim 1, wherein the reflective material layer is an electroplating chemical fusion layer, the electroplating chemical fusion layer being formed as an electroplating chemical fusion mirror on the flexible transparent material layer.

6. The safety and flexible mirror structure with a flexible back pad according to claim 1, wherein the reflective material layer is a metal fusion layer, the metal fusion layer being formed as a metal fusion mirror on the flexible transparent material layer.

7. The safety and flexible mirror structure with a flexible back pad according to claim 1, wherein the flexible transparent material layer is a flexible transparent material.

8. The safety and flexible mirror structure with a flexible back pad according to claim 1, wherein the flexible transparent material layer is selected from the group consisting of: transparent film and flexible plastic.

9. The safety and flexible mirror structure with a flexible back pad according to claim 8, wherein the flexible plastic is made of polyethylene terephthalate.

10. The safety and flexible mirror structure with a flexible back pad according to claim 8, wherein the flexible plastic is made of polyethylene naphthalate (PEN).

11. The safety and flexible mirror structure with a flexible back pad according to claim 8, wherein the flexible plastic is made of polyvinylchloride (PVC).

12. The safety and flexible mirror structure with a flexible back pad according to claim 8, wherein the flexible plastic is made of polyimide (PI).

13. The safety and flexible mirror structure with a flexible back pad according to claim 8, wherein the flexible plastic is made of polypropylene (PP).

14. The safety and flexible mirror structure with a flexible back pad according to claim 1, wherein the flexible back pad layer is made of polyethyleneimine (PEI).

15. The safety and flexible mirror structure with a flexible back pad according to claim 1, wherein the flexible back pad layer is made of tear-proof paper.

16. The safety and flexible mirror structure with a flexible back pad according to claim 1, wherein the flexible back pad layer is made of cloth.

17. The safety and flexible mirror structure with a flexible back pad according to claim 1, wherein the flexible back pad layer is made of liquid silicone gel.

18. The safety and flexible mirror structure with a flexible back pad according to claim 1, wherein the flexible back pad layer is made of liquid silicone rubber.
